(19) United States
(12) Patent Application Publication
(10) Pub. No.: US 2011/0064558 A1
(43) Pub. Date: Mar. 17, 2011

(54) Attachment for pallet jack

(76) Inventor: Peter Johnson, West Islip, NY (US)

(21) Appl. No.: 12/806,948

(22) Filed: Aug. 24, 2010

Related U.S. Application Data
(60) Provisional application No. 61/274,966, filed on Aug. 24, 2009.

(51) Int. Cl. B66F 9/18

(52) U.S. Cl. 414/800; 187/237

(57) ABSTRACT

A pallet jack attachment that is adapted to be coupled to the back support of a standard manual or a battery operated lift that has the ability to lift objects off the floor from a lifting range of zero inches to any desirable height. The attachment supports the back of any container.

This application claims priority on U.S. Provisional Patent Application Ser. No. 61/274,966, filed Aug. 24, 2009 the disclosures of which are incorporated herein by reference

### FIELD OF THE INVENTION

The present invention relates to a pallet jack attachment that is adapted to be coupled to the back support of a standard manual or battery operated lift that has the ability to lift objects off the floor from a lifting range of zero inches to any desirable height depending on the height range of the lift being used.

### BACKGROUND OF THE INVENTION

Metal containers known as postcons or general postal mail containers along with metal containers used to transport a variety of cargo from milk to all varieties of cargo have one common disadvantage. While these containers do make it easy to transport heavy loads with greatly reduced effort due to the fact that they are on wheels, they all suffer from the same unforgiving drawback. The containers are collapsible in order to make them easy to store and transport. While this is an advantage in many ways, the greatest drawback to these containers is that when an attempt is made to lift these containers, there is a good chance that they will collapse due to the fact that there are two pins holding the bottom shelf in place. These two pins are retractable in order to fold up the shelf and the container for storage. These pins commonly break and if they are in fact broken, the container cannot be lifted to waist level. These rolling stock containers mentioned are easy to maneuver from place to place but require unloading once they reach their destinations. The unloading and/or loading of these containers is an endeavor that requires a laborer to put themselves in a lifting position that requires the laborer to bend down at the knees or at the back which puts tremendous strain on the laborer's back and/or knees.

U.S. Pat. No. 6,247,887 and Pub No. 2001/0016159 relate to an apparatus that is adapted for selective mounting to an demounting from a pallet jack for use therewith or a transport vehicle having an apparatus permanently mounted thereto, which can effectively transport articles or stacks of objects, such as boxes, furniture, trays, or the like from one location to another. The apparatus comprises a housing and an article engaging and lifting member, which includes a base and a back support member for supporting the article or stack of objects. The article engaging and lifting member is pivotally mounted to the housing, preferably adjacent the bottom of the back support member.

U.S. Pat. No. 6,120,043 relates to a system for stacking continuous folded forms or web coming from a folder and separator and moving to a conveyor. A table is positioned adjacent and in line with the conveyor and in a position for receiving a horizontally extending stack of folded forms disposed on the table top. The table is a tiltable table and is able to be tilted from a horizontal to a vertical stack position. A cart is movable to a position adjacent to the tilted table for receiving from the table the vertical stack for support on the cart.

U.S. Pat. No. 5,769,595 relates to a slip sheet handling apparatus adaptable for retrofit attachment to a standard lift jack unit and is characterized by having a platen which is pivotally connected to the tines of the jack unit for tilting movement, and a gripper assembly is slidable along the platen to automatically cause upward and downward tilting movement of the platen as the gripper assembly is advanced into engagement with a slip sheet beneath a load and draws the slip sheet onto the platen in transporting the load from one site to another.

U.S. Pat. No. 5,253,972 relates to a pallet jack used for transporting a heavy roll of paper having a central hollow core. The pallet jack includes a frame with elongated arms having first and second ends, with a first set of wheels mounted at the second end of the arms, and a second set of wheels mounted near the first end of the arms. A jack is provided for jacking up the first ends of the arms so that they are spaced from the wheels. Between the arms is a cradle having first and second ends with three obtuse angle connected planar surfaces extending between the first and second ends.

U.S. Pat. No. 4,134,501 relates to a lift for servicing the running gear and underside of a vehicle, having a pair of parallel channel shaped base beams connected at their ends by extensible members. A pair of vehicle receiving platforms of channel shape are hinged to and lie directly above and parallel to the beams.

U.S. Pat. No. 4,666,004 relates to a pallet truck with a fork member movable in a up-and-down manner is provided with a plurality of load cells on the tines of the fork member for weighing loads carried by the pallet truck. Each load cell is mounted by a tine of the fork member, over which tine is floatingly mounted an elongated floating member extending substantially along the entire length of the respective member.

U.S. Pat. No. 6,042,329 relates to a pallet jack attachment coupled to the forks of a conventional pallet jack so as to be able to engage and drag a standard pallet on which goods are stacked out of a shipping container when the pallet is loaded sideways therewithin. The pallet jack attachment includes a pair of arms projecting rearwardly in spaced, parallel alignment with one another. Locking tabs are welded to the rear ends of the arms and sized to fit within and slide through existing slots formed in the forks of the pallet jack.

### OBJECTS OF THE INVENTION

It is an object of the present invention to provide a metal piece that inserts into a metal bracket.

It is an object of the present invention for the metal piece to have a hook type piece welded or formed that grabs the back of a container to be lifted and fits into a bracket.

It is an object of the present invention in one embodiment for the metal piece to slide up and down within the bracket.

It is an object of the present invention for the metal bracket to fit snugly into the pallet jack base. The bracket can be welded or bolted into the pallet jack base.

It is an object of the present invention for the pallet jack forks which are part of the pallet jack, to be raised to a height that makes it easy to lift loads by bringing the loads to waist level for most individuals.

It is an object of the present invention for the device to be used on mail postal containers, which have a folding collapsible bottom and are usually constructed out of metal with a material webbing in front.

It is an object of the present invention for the pallet jack support base to stabilize the jack when lifting the container to a waist level height.

### SUMMARY OF THE INVENTION

The present invention relates to a pallet jack attachment which is attached to the vertical support brace found on a manual, battery, or gas powered pallet jack. A preferred pallet jack for use with the present invention is a Southworth Product PML-30ME pallet mobile lifter transporter. The brace attaches vertically following the same degree angle as the piece it is being attached to on the jack. The jack itself provides the stability needed to support this piece which is to be made out of any suitable material such as steel or any hardened metal. These are the initial vertical uprights which hold two insert pieces which slide in and out of the two original pieces that attach to the jack itself. These two pieces that insert have grippers on the top of them that hold the back of a container and keep the container from collapsing. The device of the present invention acts as a safety feature, The forks or times of the pallet jack support the majority of the weight of the of the container on the jack. The back piece that is now attached to the jack prevents the container from slipping off of the jack.

In an alternative embodiment of the present invention, the attachment maybe a rod strip such as a tubular member having a length and a cross section. The rod or tubular member can be any cross section and one end of the tubular member mates with the tine support on a pallet jack. The tine supports generally have at least one upper surface where a pin or recess may be present. Where a pin is present the pin extends upwardly from an upper surface of the tine support to an opening in one end of the attachment of the present invention. Where there is a recess in the upper surface of the tine support, the pallet jack attachment is received by that recess and retained in position in the recess. The attachment extends upwardly from the tine support such that the attachment is generally perpendicular to the tines. The end of the attachment opposite the tine support is provided with a support member extending outwardly of the attachment in generally the same direction as its respective tine. The support member is preferably a plate and extends generally perpendicular to the body of the attachment. At the free end of the support member there is a guide member extending upwardly. The guide member prevents the post-con of a container such as a portion container from sliding off of the support member.

The attachment supports the back of any metal container that was not meant to be lifted due to the fact that these metal containers and in some cases plastic shell containers commonly referred to as rolling stock or post cons have collapsible bottoms which cause these wheeled containers to fold when weight is placed underneath them when attempting to lift off the floor. This collapsing can cause great injury to an individual if the container would fall.

The device works by placing the pallet jack having pallet jack forks under a container having a folding collapsible bottom. The container can also have wheels. The pallet jack forks are placed underneath the collapsible bottom of the container. The attachment which is attached to the pallet jack is attached to the container. The pallet jack forks lift the collapsible bottom, but the container is being prevented from falling off of the pallet jack by the attachment.

The device of the present invention attaches to the back of a pallet jack. It is an object of the present invention for the device to be a permanent attachment to the pallet jack. It is an object of the present invention for the device to be adapted to any type of lifting type pallet jack. It is an object of the present invention to being any contents that need to be unloaded from the container to an ergonomically correct unloading or loading level in order to reduce back and knee injuries resulting from incorrect lifting procedures.

The device of the present invention brings existing loads to an appropriate level by lifting a container safely by changing the pressure point of the container to be lifted from the bottom of the container to the back of the container taking the pressure off of the bottom of the container.

### BRIEF DESCRIPTION OF THE DRAWINGS

FIG. 1 shows a side view of one embodiment of the present invention attached to a pallet jack.

FIG. 2 shows a front view of the embodiment of FIG. 1 attached to a pallet jack lifting an object.

FIG. 3 shows the attachment of FIG. 1.

FIG. 4 shows the attachment of FIG. 1.

FIG. 5 shows an example of how the attachment is attached to the pallet jack.

FIGS. 6-9 show how the device of FIG. 1 generally operates.

FIG. 10 shows an alternative embodiment of the present invention attached to a pallet jack.

FIG. 11 shows a front view of the embodiment of FIG. 10.

FIG. 12 shows the attachment of FIG. 10

FIG. 13 shows a side view of the attachment of FIG. 10

FIG. 14 shows a post-con and a pallet jack.

FIG. 15 shows a post-con and pallet jack aligned prior to lifting.

FIG. 16 show a post-con and pallet jack where the post-con ready for lifting with the “grab back” feature of the present invention in place.

FIG. 17 shows the post-con being lifted by the pallet jack.

### DETAILED DESCRIPTION OF THE INVENTION

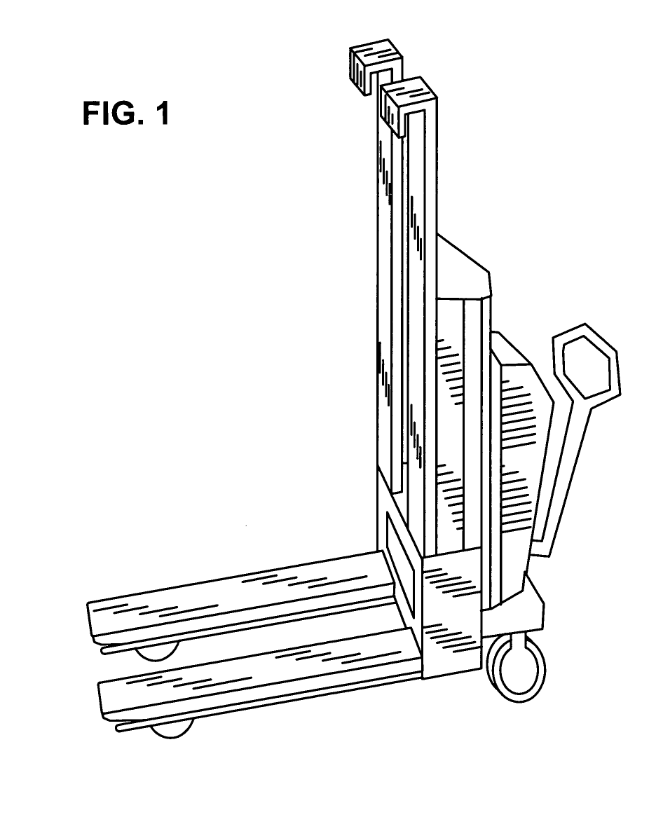

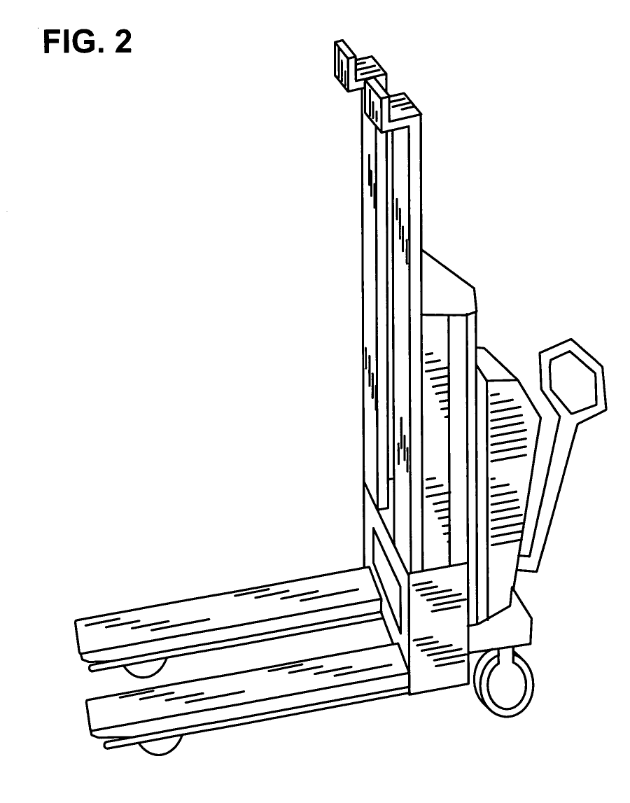

FIG. 1 shows a side view of the device of the present invention attached to a pallet jack. FIG. 2 shows a front view of the device of the present invention attached to a pallet jack lifting an object.

The device of the present invention includes a first generally tubular member 1 that inserts into a corresponding opening in metal bracket 2. The piece 1 has a hook type piece welded or formed that grabs the back of the container to be lifted and fits into bracket 2 and slides up and down within bracket 2. Metal bracket 2 fits snugly into pallet jack base 3. Bracket 2 can be welded or bolted into pallet jack base 3.

Pallet jack forks or tines 4 which are part of the pallet jack 7 can be raised to a height that makes it easy to lift loads by bringing the loads to waist level for most individuals. General mail postal container 5 (post-con) has a folding collapsible bottom 6 and is usually constructed out of metal with a material webbing in front. A preferred container for use with the invention is shown in U.S. Pat. No. 3,908,562 the disclosures of which are incorporated herein by reference. These containers have a mesh type frame with a plurality of horizontal metal members at various locations on the container such as near the base, the top and one or more locations on the body of the container. The body of the container also includes a plurality of vertical members that may be like metal wires extending from the top to the base of the container. The rolling containers have hard rubber wheels 8 for easy transport. The pallet jack support base 9 stabilizes the jack when lifting the container to a waist level height by hooking on to the horizontal metal members on the container and preventing it from moving off of the tines when the container is lifted by the pallet jack.

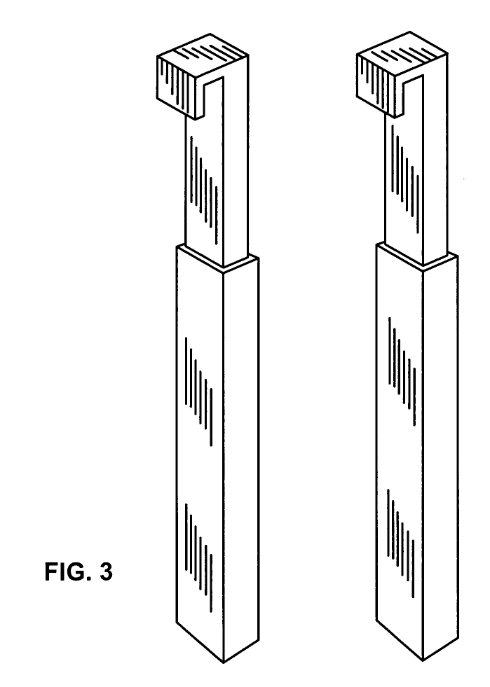

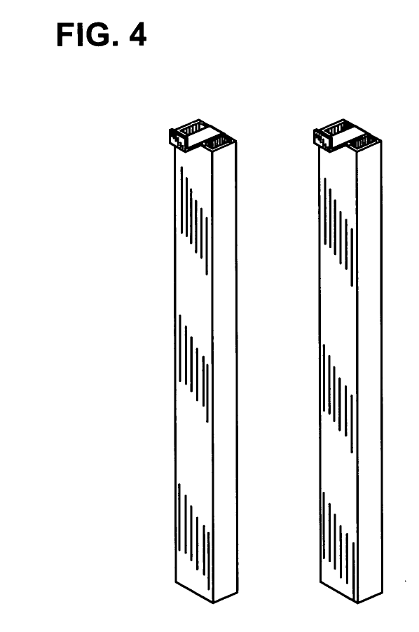

FIGS. 3 and 4 show the attachment of the present invention.

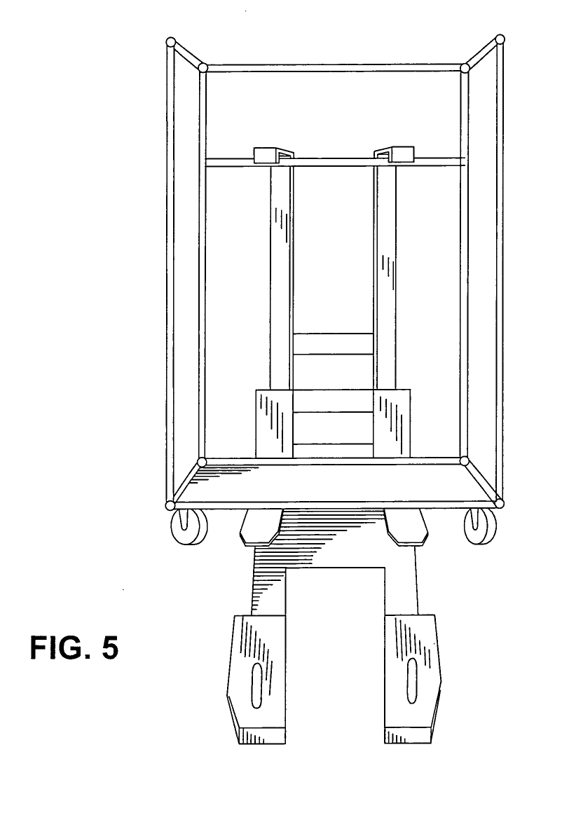

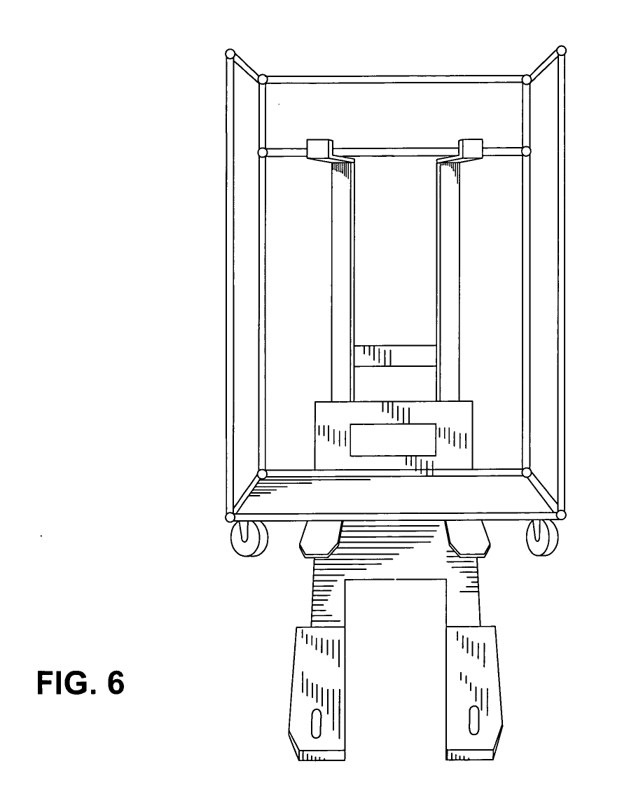

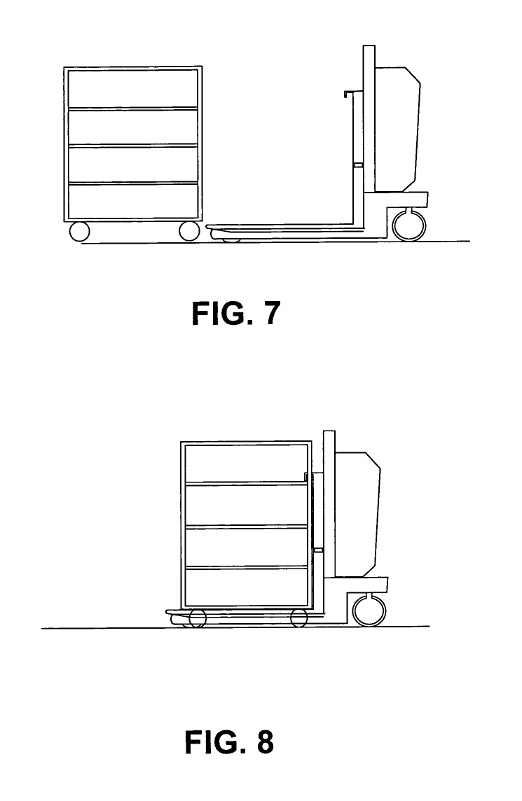

FIG. 5 shows how the attachment is attached to the pallet jack.
FIGS. 6-9 show how the device of the present invention works. FIG. 6 shows the pallet jack 7 having pallet jack forks 4 being placed under a container 5 having a folding collapsible bottom 6 and hard rubber wheels 8. FIG. 7 shows the pallet jack forks 4 underneath the collapsible bottom 6. FIG. 8 shows the attachment comprising 1 and 2 being attached to the pallet jack 7 and attached to the container 5. FIG. 9 shows the pallet jack forks 4 underneath the collapsible bottom 6, but the container 5 is being support by the attachment comprising pieces 1 and 2. As seen in FIG. 10 there is an alternative embodiment of the attachment of the present invention. There is a pallet jack 100 that has a pair of tines 101 that can be raised and lowered as desired by the pallet jack. The pallet jack has a plate or tine support 102 from which the tines 101 of the pallet jack extend. On an upper surface 103 of the plate there may be a pin over which tubular member 104 may be placed to hold the tubular member in place. Alternatively, tubular member 104 may be received by a recess in the top surface 103 of the plate 102. The pin or recess are generally sized and shaped to mate with the tubular member. For example, where the tubular member 104 has a rectangular cross section, the pin will also typically have a rectangular cross section so the tubular member is positioned over the pin. This arrangement holds the tubular member generally in a vertical orientation. Similarly where the upper surface 103 of the plate has a recess the opening member corresponds so that the tubular member may be held in the generally vertical position as shown in FIG. 10.

The tubular member may be any length as desired. Although a generally rectangular cross section is shown in the Figures it will be appreciated that the cross section of the tubular member may be any desired shape. Also, the tubular member may be solid or it may be hollowed over all or a portion of its length.

The tubular member has a first end 105 and a second end 106. The first end is the portion of the tubular member that is in proximity to the top surface 103 of the plate. The second end is at the opposite end of the tubular member. The second end of the tubular member 104 is provided with a hook means 107. The hook means 107 has a support member 108 that is generally perpendicular to the tubular member. This support member is also generally parallel to the tines 101. The first support member 108 is a support for a portion of the post-con being held by the pallet jack. The first support member has a first end 109 secured to the tubular member 104 and a second end that has a guard member 110 extending upwardly therefrom. The guard member is preferably generally parallel to the tubular member 104 and generally perpendicular to the support member 108. The support member extending from the attachment may integral with the attachment or it may be a separate member that is secured to the attachment by any suitable means including but not limited to welding. The same is true with respect to the guide member. The guide member may also be separate from the support member or it may be integral with it. The container to be supported rests on the support member and is prevented from slipping off the support member by the guide member which extends upwardly. The support member and the guide member may be any suitable width. For example, in one embodiment the support member may be as wide as the width of the tubular member. In other embodiments it mat be narrower or wider than the width of the tubular member. The same is true of the width of the guide member.

As seen in FIG. 2 the support member 108 contacts a generally horizontal bar 11 of the post-con and the horizontal bar rests on each of the two support member 108. The guard member 110 prevents the horizontal member 111 of the post-con from sliding off of the support member 108. In this manner the post-con is supported by the two tines 101 of the pallet jack and the support members 108. The guard member 110 hold the post-con in position when the tines lift the post-con. The guard member basically grabs the back of the nail container. This differs from the embodiment shown in FIGS. 1-9 in that the horizontal bar of the post-con is actually supported by the support member 108 whereas in the first embodiment there is no support under the horizontal bar 111 and the attachment of the first embodiment merely prevents the post-con from tipping over when tines of the pallet jack lift the post-con.

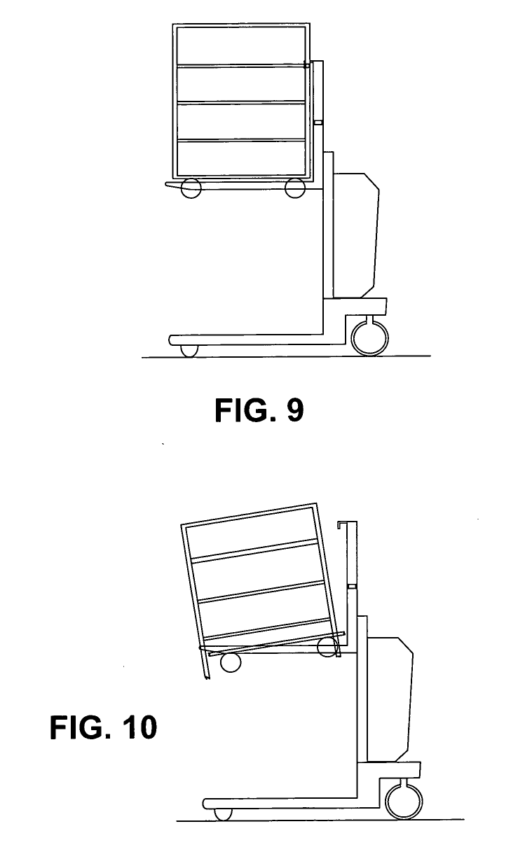

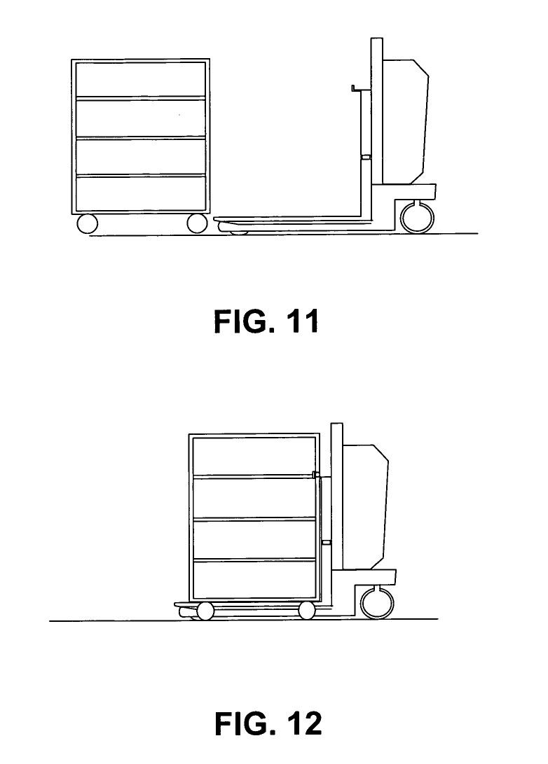

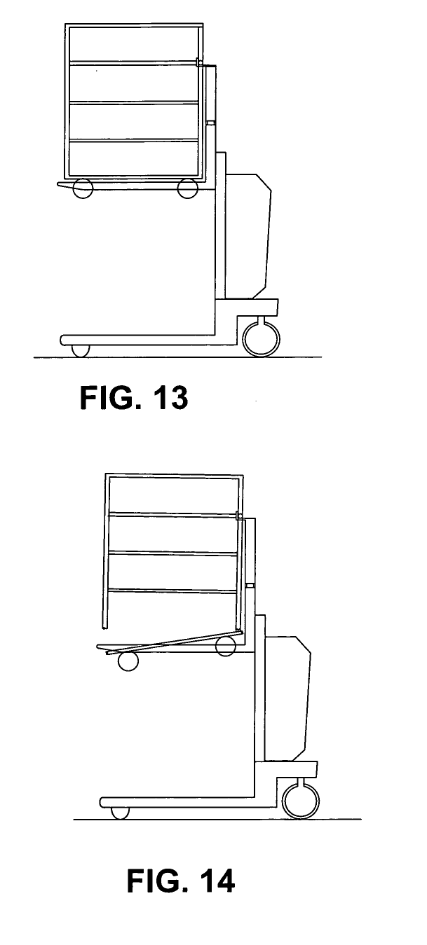

FIG. 12 shows the attachment of FIGS. 10 and 11 without the presence of the pallet jack. FIG. 14 shows the plate 102 of the pallet jack having an orifice 120 in the upper surface 103 of the plate. The orifice 120 is sized and shaped to receive the attachment 104. Securing means 121 may be present to connect the attachment to the plate 102 of the pallet jack.

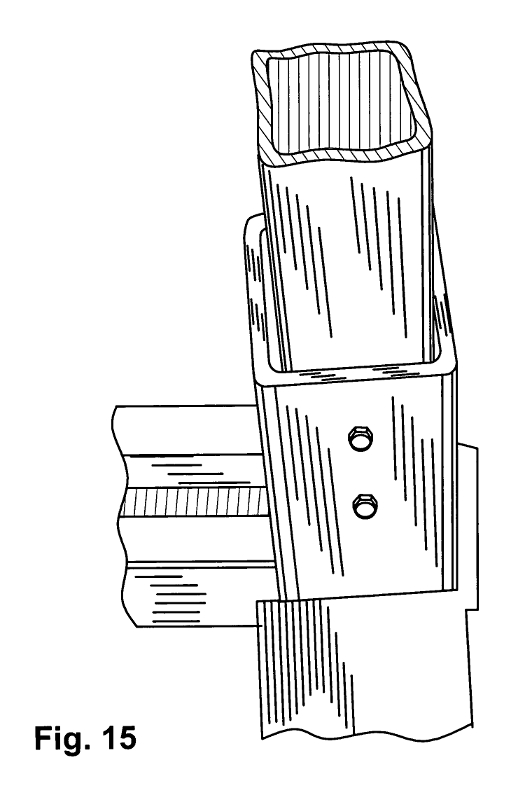

FIGS. 14-17 show the operation of the attachment. There is a pallet jack 130 and a post-con 131. The post-con has an underside or bottom that is raised off of a floor surface by a plurality of wheels. The tines of the pallet jack are inserted underneath the post-con. In operation the pallet jack and the support member prevent the container such as a U.S. Postal Service post-con from tipping as it is lifted by the tines. In the absence of the support member and guard of the attachment of the present invention there is a higher risk of injury to users of a pallet jack to lift a post-con or other container.

The present application has particular applicability for use with a U.S. Postal Service Mail Container, General Purpose, USPS Drawing No. MDL-217576, USPS Contract No 104230-85-VHO22 described in U.S. Pat. No. 3,908,562, the disclosures of which are incorporated herein by reference.

A second type of container is referred to as a Net Post-con. It is also referred to as U.S. Postal Service Container ERMC, USPS Drawing No. MDL 226120Contract No. 10-4230-87-V-H316.

1. A pallet jack attachment comprising:
an attachment;
said attachment being attached to vertical support brace of said pallet jack;
said attachment comprising a gripper to grip a top of a container while said container is being supported by one or more tines of a pallet jack.

2. The pallet jack attachment of claim 1 wherein said attachment attaches vertically following same degree angle as the vertical support brace it is attached to on said jack.

3. The attachment of claim 1 wherein said attachment comprises steel or any hardened metal.

4. The attachment of claim 1 wherein said attachment comprises:
vertical uprights which hold two insert pieces which slide in and out of said vertical uprights.

5. The attachment of claim 1 wherein said attachment prevents a container positioned on said tines from slipping off said tines.

6. The attachment of claim 1 wherein said container comprises a collapsible bottom.

7. A pallet jack attachment comprising:
a metal piece that inserts into a metal bracket;
said metal piece comprising a hook type member formed on said metal piece that grabs a back of a container to be lifted to prevent said container from falling off a pair of tines on a pallet jack.

8. The attachment of claim 7 wherein said metal piece slides up and down within said bracket.

9. The attachment of claim 7 wherein said metal bracket fits snugly into a pallet jack base.

10. The attachment of claim 8 wherein said bracket is welded or bolted into said pallet jack base.

11. A method of lifting a container having a collapsible bottom comprising:
placing a pallet jack having pallet jack forks under a container having a folding collapsible bottom;
placing said pallet jack forks underneath said collapsible bottom of said container;
attaching an attachment of said pallet jack to back of said container;
lifting said container bottom with said pallet jack forks while supporting container with said attachment.

12. The method of claim 11 further comprising:
changing pressure point of said container to be lifted from said bottom of said container to back of said container.

13. A pallet jack attachment comprising an tubular member, said tubular member having a first end and a second end, said first end being removably secured to an upper surface of a plate on a pallet jack, said plate said plate having a tine extending therefrom, said tubular member having a second end opposite said first end, said second end having in proximity thereto a support member said support member extending outwardly from said tubular member and having a first end and a second end said first end being secured to said tubular member and said second end having a guard member extending upwardly therefrom, said support member and wherein a container is supported by said tine said support member and prevented from tipping.

14. The pallet jack attachment according to claim 13 wherein there is a first tine and a second tine and a first attachment and a second attachment.

15. The pallet jack attachment according to claim 14 where said support member is generally perpendicular to said tubular member and generally parallel to said tine

16. The pallet jack attachment according to claim 15 wherein said guard member is generally perpendicular to said support member and generally parallel to said tubular member.

17. The pallet jack according to claim 16 wherein said container is collapsible.

18. The pallet jack according to claim 17 wherein said container is a post-con.

19. The pallet jack according to claim 18 wherein said support member is a flat plate.

20. The pallet according to claim 19 wherein said post-con has a plurality of wheels that raise a bottom surface of said post-con so that said times can be inserted underneath said surface.

21. The pallet jack according to claim 13 wherein said container has a collapsible bottom.

22. The pallet jack according to claim 20 wherein said plate on said pallet jack has a recess in a top surface thereof for receiving said attachment.
